(19) United States
(12) Patent Application Publication
(10) Pub. No.: US 2010/0203781 A1
(43) Pub. Date: Aug. 12, 2010

(54) Light weight insulated, flexible buoyant article

(76) Inventor: Walter Gellatly, Ogden, UT (US)

Correspondence Address: Walter Gellatly, 3462 Jefferson, Ogden, UT, 84403, US

(21) Appl. No.: 12/322,627

(22) Filed: Feb. 6, 2009

(51) Int. Cl. B63C 9/087; B32B 3/10

(52) U.S. Cl. 441/129; 428/304.4; 428/137

(57) ABSTRACT

An insulated, flexible article having insulating properties, as well as light weight and excellent buoyancy characteristics, and comprising a core mat with individual close spaced air or flexible other gas filled cells made of thin, highly flexible plastic and with one or both faces of the mat having one or more flexible face sheets laminated to the core mat to form a composite sheet that can be shaped using patterns and sewn, bonded or otherwise assembled to be a flexible, insulative and buoyant article.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

This invention relates to insulated, flexible articles such as garments having insulating properties, as well as light weight, and excellent buoyancy characteristics.

It has long been common to use air filled bladders and/or compartments, attached by belts, straps or other securement means to the upper torso of a person, to provide buoyancy to such person in water.

Neoprene rubber materials have been developed that contain miniscule air bubbles trapped in the material mass during manufacture. These materials are formed into sheets from which clothing articles, such as wet suits, hoods, gloves and boots, worn by scuba divers are formed by sewing, bonding, or the like. The neoprene sheets may be reinforced by bonding layers of a material, such as nylon fabric, to them, to make them more resistant to tearing, puncturing and the like. The formed garments produced using such neoprene sheets serve to insulate the wearer, while at the same time providing buoyancy when in water. In the event water gets inside neoprene clothing items, the body heat of the user will warm the water to a temperature that will allow the user to be comfortable, or at least will provide long term survivability. Consequently, neoprene materials have proven to be very suitable for use in dive suits and related items. However, neoprene material is more dense and heavy than is required for many other types of clothing articles. Also, neoprene materials, even when reinforced do not withstand significant tearing forces. Furthermore, neoprene materials are costly and therefore are not always suitable for use in the production of general type protective clothing. Garments made from neoprene are often uncomfortable when worn while working out of a water environment.

There remains a need for clothing articles and the like, made from materials that are light weight, have good durability, and that provide excellent insulation and flotation characteristics. Commercial fishermen, for example, need clothing items, such as jump suits, trousers, and jackets that allow freedom of movement as they work, but that will provide warmth and flotation should they wind up in cold water. A suitable material can desirably be used by employing conventional sewing methods to construct insulating and buoyant protective garments. For example, jackets, ponchos, coveralls, ski pants, vests, etc., used by workers, hunters, fishermen, farmers, snowmobilers, skiers, pilots, and others can be sewn using standard available clothing patterns with a suitable insulating and buoyancy providing material. A suitable material can also be used for the low cost production of insulating gear, such as sleeping bags, thermal insulating pads and blankets, and buoyancy providing and insulating life preservers of different kinds and styles.

### BRIEF SUMMARY OF THE INVENTION

### Objects of the Invention

It is a principal object of the present invention to provide a flexible, light weight composite material having excellent insulating properties, that is buoyant and that has a central layer providing flotation and insulation, and that does not absorb water.

Another object of the invention is to provide a flexible composite material that can be readily fabricated using conventional available equipment to form low cost protective clothing articles that not only will keep a user sufficiently warm, even if the user is in subzero temperatures, or icy water for an extended time period, but that will also serve as a buoyant life preserver, if necessary.

Another object of the invention is to provide a flexible material suitable for manufacture into garments and other articles that are both insulative and buoyant, utilizing conventional patterns and sewing techniques, and that is a composite sheet made from laminated light weight, flexible plastics and fabrics.

### Features of the Invention

In accordance with the objects set forth above, the invention comprises a water repellent composite sheet of flexible material made of an insulative and buoyant flexible plastic central core material having individual close packed air, or other gas filled cells, or bubbles that are held in a desired spacing by a thin, flexible, sheet of plastic and having at least one thin, flexible outer layer of fabric material. The cells of the core material can be a grouping of individual, spaced apart cells positioned on a face of a flexible thin plastic mat. The formed mat with cells thereon has opposite faces bonded to layers of flexible fabric material to form a laminated composite sheet of material suitable for sewing in the manufacture of garments and other articles. The individual cells are filled with air or other suitable gas so that each cell becomes a buoyant insulating pocket of air, or other gas. The size, shape and spacing between cells can be as desired for a particular article to be manufactured, but it is generally preferred that the cells be closely spaced and even in touching relationship to provide maximum insulation and flotation, while maintaining flexibility to allow shaping and sewing in the production of garments. The flexibility of the composite material also allows a full range of user movement while wearing a formed garment of the composite material.

The mat, having interconnected, close packed air, or other gas filled cells, has one or both opposite faces covered with a sheet of thin, flexible fabric cover material. The sheet material covering the faces of the material is a durable fabric, such as rip-stop nylon. The cover material is bonded to the mat, as by adhesive bonding, heat bonding, or any other suitable bonding method. When both opposite faces are covered the spaces between cells form air retention spaces that further add to the insulation and buoyancy properties of garments formed with the composite mat.

More than one mat containing cells can be used in the composite material sheet formed, but it is highly preferable that the overall thickness of the composite sheet of material not exceed about three-fourths of an inch so that the formed sheet can be used in the same manner as any other single layer fabric in the production of desired insulating and floatation articles. Thus, the mat can be cut to desired shapes and can be sewn using patterns and conventional sewing machines into clothing, or other insulating and flotation support providing garments. Regardless of the cover materials used, the formed, laminated mat will not absorb any significant amount of water since the core of the material is of non-water absorbing plastic and the material will be light weight, while still affording excellent insulating and buoyancy characteristics.

Even if small holes are provided through the core between adjacent bubbles to make the composite material “breathable”, i.e., capable of allowing moisture (sweat) and excess heat to escape when a garment is worn while working, for example, the user is maintained warm and comfortable. Water entering a garment of the invention is warmed by the body heat of the wearer and does not circulate. As a result, even though a wearer's body temperature may drop off in cold water, sufficient body heat will remain for a wearer to survive even if floating in very cold water for an extended period of time.

Additional objects and features of the invention will become apparent to persons skilled in the art to which the invention pertains from the following detailed description, drawings and claims.

### BRIEF DESCRIPTION OF THE FIGURES OF THE INVENTION

### In the Drawings

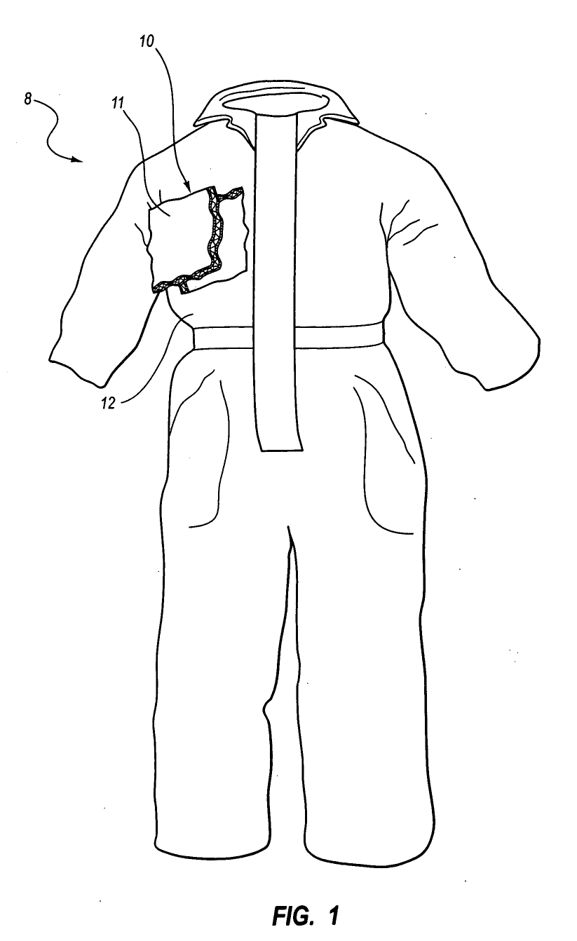

FIG. 1 is a front elevation view of a snowsuit article of the invention;

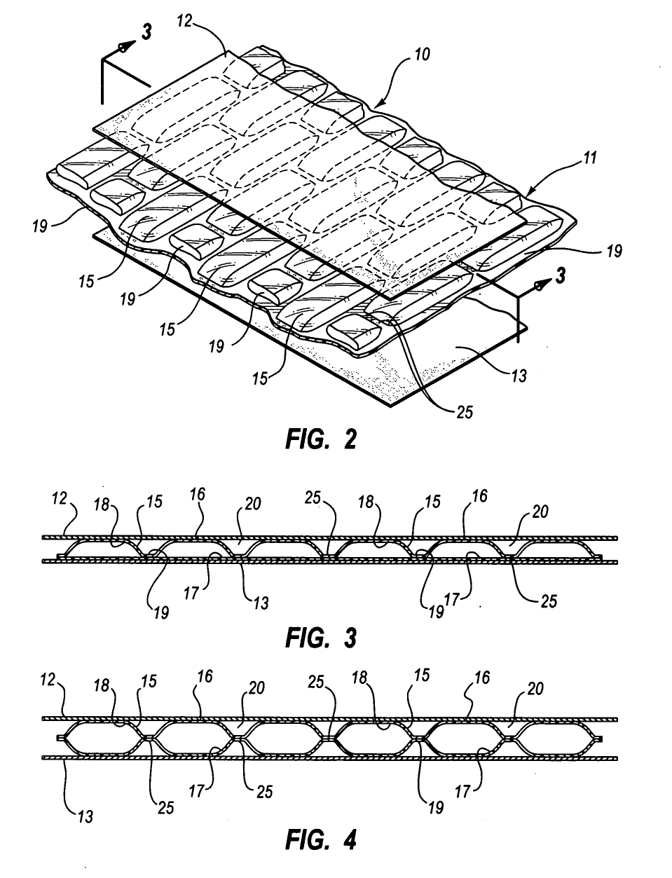

FIG. 2, is an exploded, perspective view of a segment of a typical garment (snowsuit) of the invention;

FIG. 3, a section taken on the line 2-2 of FIG. 1; and

FIG. 4, a view like that of FIG. 3, but showing a different core mat.

### DETAILED DESCRIPTION

Referring Now the Drawings

In the illustrated preferred embodiment of the invention, an article 8, shown as a snowsuit is formed from components cut using a pattern from out of a composite sheet of insulative and buoyant material, shown generally at 10. Sheet 10 includes a flexible core mat 11, sandwiched between a pair of flexible cover sheets 12 and 13, respectively.

Core mat 11 consists of interconnected individual air or other gas filled cells 15. The cells are made of two or more layers 16 and 17 of flexible, stretchable sheet plastic, with one (FIG. 2), or both layers (FIG. 3) formed with pockets 18 and the other layer closing the pockets and trapping air or other gas therein. If both layers are formed with pockets 18, the pockets of one layer may overlay the pockets of the other layer in a mirror image relationship to close the pockets and to form larger cells 15 than will be formed if only one sheet 16 or 17 is provided with pockets and the other sheet is flat. The portions of the layers 16 and 17 of sheet materials surrounding each cell 15 are bonded together at 19 to hold the cells in spaced relation as a mat.

Preferably, the cells 15 of the mat 11 are as closely spaced as possible to thereby serve as dead air insulators over a maximum portion of the mat surfaces. The cells are also spaced sufficiently far apart to allow bending of articles formed and including the mat 11.

The flexible cover sheets 12 and 13 may be made of a variety of materials, with the selection of materials used being primarily dependent upon the use or uses to be made of the composite material formed. Thus, the cover sheets may be of a cloth fabric material such as nylon, or re-enforced nylon, cotton, or polyethylene, or blends or combinations of these and other fabrics, as well. For most uses, however, it is desirable that if a cloth fabric, or a pair of different cloth fabrics be used as the flexible cover sheets, the fabrics have a tight weave so that with the cover sheets in place the spaces 20 between cells 15 will also serve to trap air between the mat 11 and the cover sheets to give good insulating properties to garments made from the composite material.

Other materials can be used for one or both of the cover sheets 12 and 13. Plastic sheeting materials can be used, for example. Such plastic materials are particularly advantageous, for example, when the composite material formed is to be used in making life preservers or other such articles that will provide both buoyancy and warmth to a wearer under conditions where breathing of the material is not required and the composite material can be made totally water impervious.

When it is desired that the composite material formed be “breathable”, that is, that it allow air movement from one side to the other while still providing excellent insulation and buoyancy to the user, the cover sheets 12 and 13 are preferably made of a fabric material that will allow such breathing and holes 25 are provided through portions 19 of the plastic sheets 16 and 17 from which the cells are formed to permit air flow therethrough. Even though some water may pass through the fabric materials used for cover sheets 12 and 13, the composite material will, because of the cells 15, still provide insulation and buoyancy. Such a composite material is particularly useful in the making of garment articles, such as trousers, jackets, coveralls, and specialized gear such as snowmobile suits and ski suits. In the manufacture of garments, as in the manufacture of other items, the material can be cut according to any desired pattern. The cut pieces can then be attached to make the item in conventional fashion, such as by sewing or, particularly if the cover sheets and the core are all of plastic, by bonding with adhesives or heat.

Clothing articles manufactured using the composite material of the invention will protect any person using such items from the cold and, should it be necessary, will keep the person afloat. At the same time, garments made with the composite material can be light weight and relatively inexpensive when compared to many protective clothing items currently available on the market.

Although a preferred embodiment of my invention has been herein described, it is to be understood that the present disclosure is by way of example and that variations are possible without departing from the subject matter coming within the scope of the following claims, which subject matter I regard as my invention.

I claim:

1. An insulated, buoyant article comprising
pattern shaped flexible fabric components cut and assembled in formation of the articles; and
each pattern shaped component being formed from a flexible composite sheet comprising at least one fabric layer laminated to at least one thin, flexible sheet of core material with gas filled cells on at least one face thereof.

2. An insulated, buoyant article as in claim 1, wherein
the pattern shaped components are sewn together to form the article.

3. An insulated, buoyant article as in claim 2, wherein
the article is a garment.

4. An insulated, buoyant article as in claim 1, wherein
the flexible composite sheet comprises a pair of flexible sheets of fabric laminated to the sheet of core material.

5. An insulated, buoyant article as in claim 1, wherein
the thin flexible sheet of core material has holes therethrough between gas filled cells.

6. An insulated, buoyant article as in claim 4, wherein
the flexible composite sheet includes a pair of sheets of core material laminated between the sheets of flexible fabric material.

7. An insulated, buoyant article as in claim 3, wherein
the flexible composite sheet comprises a pair of flexible sheets of fabric laminated to the sheet of core material.

8. An insulated, buoyant article as in claim 7, wherein
the thin flexible sheet of core material has holes therethrough between gas filled cells.

9. An insulated, buoyant article as in claim 7, wherein
the flexible composite sheet includes a pair of sheets of core material laminated between the sheets of flexible fabric material.
